(19) United States
(12) Patent Application Publication
(10) Pub. No.: US 2007/0267985 A1
(43) Pub. Date: Nov. 22, 2007

(54) Flat Panel Display Having Backlight Module

(76) Inventors: Wen-Tsung Lin, Tainan (TW); Ching-Liang Lin, Kaohsiung County (TW); Shih-Ming Chen, Tainan City (TW)

Correspondence Address: FISH & RICHARDSON PC, P.O. BOX 1022, MINNEAPOLIS, MN, 55440-1022, US

(21) Appl. No.: 11/747,850

(22) Filed: May 11, 2007

(30) Foreign Application Priority Data
May 12, 2006 (TW) 95117008

(51) Int. Cl. H05B 39/00

(52) U.S. Cl. 315/312

(57) ABSTRACT

A display includes a backlight module having elongated lamps. At least a pair of the lamps has a first lamp and a second lamp that are electrically connected in series. The first lamp and the second lamp are spaced apart with at least a third lamp positioned between the first and second lamps.

### CROSS REFERENCE TO RELATED APPLICATIONS

The application claims priority to Taiwan Application No. 95117008, filed May 12, 2006, the contents of which are incorporated by reference.

### BACKGROUND

This document relates to flat panel displays having backlight modules.

FIG. 1 is a diagram of an example of a conventional backlight module 100 of a liquid crystal display (LCD) panel. The backlight module 100 includes straight cold cathode fluorescent lamps (CCFLs) 102 positioned in parallel to one another. Ballast capacitors 104 are positioned at two ends of each CCFL 102. External electrode fluorescent lamps (EEFL) can also be used in the backlight module 100.

FIG. 2 is a diagram of another example of a conventional backlight module 100 that uses “quasi-U lamps” L1 to L6, each being formed by series connecting adjacent straight CCFLs to form a quasi-U-shaped lamp. For example, a quasi-U-shaped lamp L1 includes lamps C1 and C2 that are adjacent and in parallel to each other, in which an end 112a of the lamp C1 is connected to an end 112b of the lamp C2, forming a quasi-U-shape. The lamp C1 has an end 114a that is connected to a power source A1 through a ballast capacitor, and the lamp C2 has an end 114b that is connected to a power source A2 through a ballast capacitor.

### SUMMARY

In one aspect, in general, a display includes a backlight module having elongated lamps that include at least a pair of lamps having a first lamp and a second lamp that are electrically connected in series and being spaced apart with at least a third lamp positioned between the first and second lamps.

Implementations of the display may include one or more of the following features. The lamps are connected in pairs in which the pairs of lamps are selected to compensate for differences in temperatures of the lamps during operation of the lamps. The pair of lamps are connected in a quasi-U-shape. The apparatus includes a circuit board having at least one signal line for connecting the at least one pair of lamps. The elongated lamps extend along directions that are parallel to one another. The backlight module includes an inverter to provide power to the lamps. The first lamp has a first end electrically coupled to the inverter, the second lamp has a first end electrically coupled to the inverter, and the first lamp has a second end electrically coupled to a second end of the second lamp. The backlight module includes a first ballast capacitor connected between the inverter and first end of the first lamp, and a second ballast capacitor connected between the inverter and first end of the second lamp. The backlight module includes ballast capacitors each connected between the inverter and one of the lamps.

The inverter includes two alternating-current power sources. The lamps are positioned in sequence, one of the two alternating-current power sources providing power for odd-numbered lamps, and the other of the two alternating-current power sources providing power for even-numbered lamps. The lamps include at least one of cold cathode fluorescent lamps and external electrode fluorescent lamps. The pair of lamps has luminance characteristics similar to a U-shape or C-shape lamp. Each of the elongated lamps extend along a direction parallel to a row of pixels of the display. The lamps are connected to compensate for temperature variations in the lamps to enable the backlight module to have a luminance that is more uniform than a backlight module having pairs of lamps connected in series in which each pair includes lamps that are adjacent to each other. The lamps include m lamps positioned in sequence in which the n-th lamp has an end that is electrically coupled to an end of the (m+1−n)-th lamp. The pair of lamps includes a lamp having the highest position and a lamp having the lowest position among the lamps.

In another aspect, in general, a display includes a display panel having pixels and a backlight module to provide backlight for the display panel. The backlight module includes an inverter to provide power, and elongated fluorescent lamps that are powered by the inverter. The fluorescent lamps include at least a first fluorescent lamp and a second fluorescent lamp that are electrically connected in series, in which the first fluorescent lamp has a first end electrically coupled to the inverter, the second fluorescent lamp has a first end electrically coupled to the inverter, the first fluorescent lamp has a second end electrically coupled to a second end of the second fluorescent lamp, and the first and second fluorescent lamps are spaced apart with at least a third fluorescent lamp positioned between the first and second fluorescent lamps.

In another aspect, in general, a method includes compensating a difference in luminance of different lamps of a backlight module of a display by electrically coupling a first one of the lamps to a second one of the lamps that is spaced apart from the first one of the lamps in which at least a third one of the lamps is positioned between the first one and second one of the lamps.

Implementations of the method may include one or more of the following features. The method includes balancing the temperatures of the first one and second one of the lamps during operation of the first one and second one of the lamps. The method includes compensating variation in electric current flowing through the lamps by electrically coupling a first one of the lamps to a second one of the lamps that are spaced apart from the first one of the lamps in which at least a third one of the lamps is positioned between the first one and the second one of the lamps. The method includes coupling a ballast capacitor between a power source and each of the lamps. The lamps include at least one of cold cathode fluorescent lamps and external electrode fluorescent lamps. The method includes powering the lamps using two alternating-current power sources. The lamps are positioned in sequence, and the method further includes coupling a first alternating-current power source to odd-numbered lamps and coupling a second alternating-current power source to even-numbered lamps. The method further includes connecting the first one of the lamps to the second one of the lamps using a signal line on a circuit board. The method further includes illuminating a liquid crystal display panel using the backlight module.

The disclosed displays and techniques may provided one or more of the following advantages. The backlight module can have a high luminance uniformity. Luminance uniformity can be maintained when there is a large difference in temperature between different lamps. Power lines between the inverter and the fluorescent lamps can be short to reduce leakage current.

The details of one or more implementations are set forth in the accompanying drawings and the description below. Other features, aspects, and advantages will be apparent from the description and drawings, and from the claims.

### DESCRIPTION OF DRAWINGS

FIGS. 1 and 2 are schematic diagrams of conventional backlight modules.

FIG. 3 is a schematic diagram of a backlight module.

FIG. 4 shows a backlight module.

FIGS. 5A, 5B, 6A, and 6B are graphs.

FIG. 7 is a schematic diagram of a backlight module.

FIGS. 8A and 8B are graphs.

FIG. 9 is a schematic diagram of a backlight module.

FIGS. 10A and 10B are graphs.

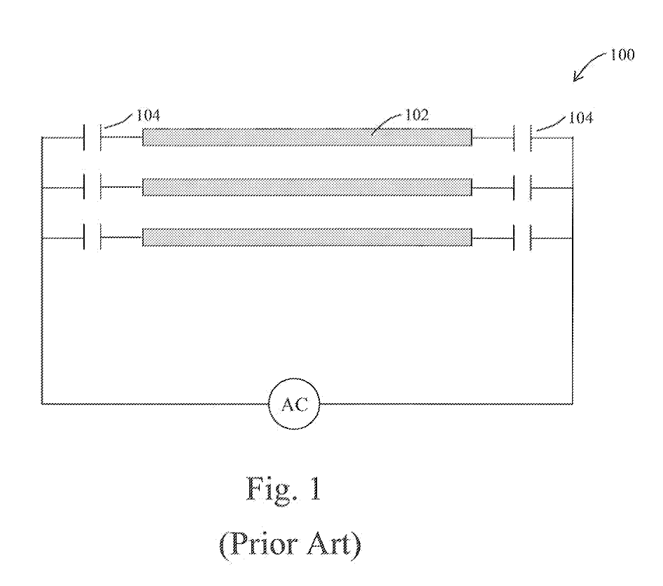

### DETAILED DESCRIPTION

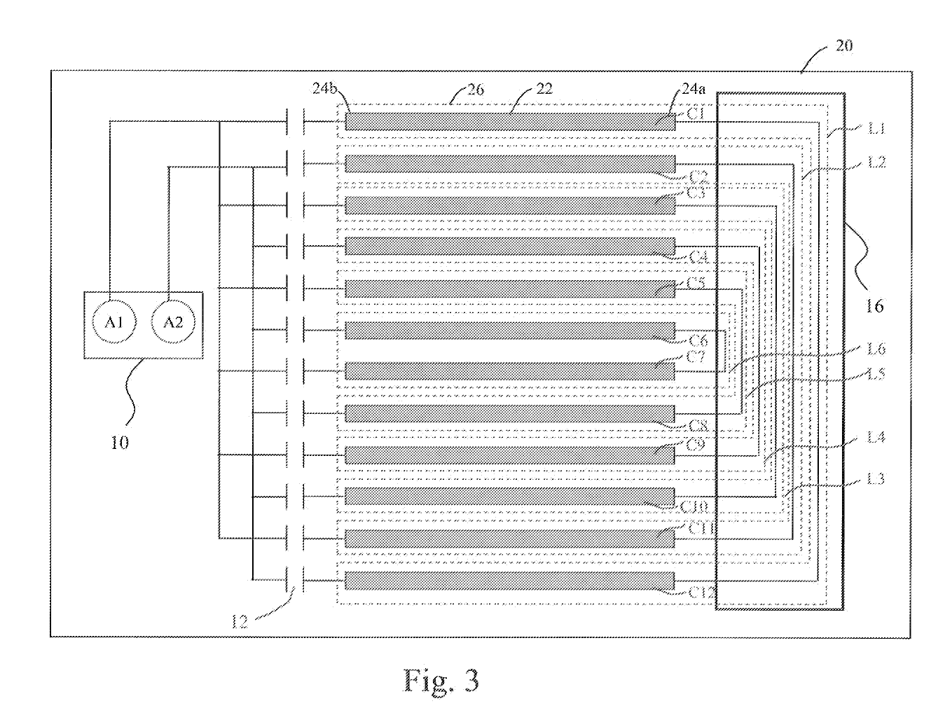

FIG. 3 is a schematic diagram of an example of a backlight module 20 of a display (e.g., liquid crystal display) that includes elongated lamps 22 (e.g., C1 to C12) that are positioned horizontally. The lamps 22 can be, e.g., cold cathode fluorescent lamps (CCFL) having straight tubes. The lamps 22 extend along directions that are parallel to rows of pixels of the display. The lamps 22 are connected in a way so as to compensate for differences in luminance of the lamps 22 due to differences in temperatures of the lamps 22. This is achieved by connecting pairs of lamps that are spaced apart and having different temperatures so as to compensate differences in lamp temperatures such that similar amounts of electric currents flow through different pairs of lamps.

When the display is operating in an upright or tilted position, some of the lamps (e.g., C1) are located at positions higher than the other lamps (e.g., C12). In the example of FIG. 3, lamps at an upper portion of the figure represent lamps that are at higher positions when the display is at an upright position. The lamps (as well as other circuitry of the display) generate heat that rises to cause the upper lamps to have higher temperatures than the lower lamps, causing the upper lamps to have a higher luminance than the lower lamps. When a given voltage is applied to a lamp, increasing the temperature of the lamp lowers the internal resistance of the lamp, resulting in an increase in the electric current flowing through the lamp and a corresponding increase in the luminance of the lamp.

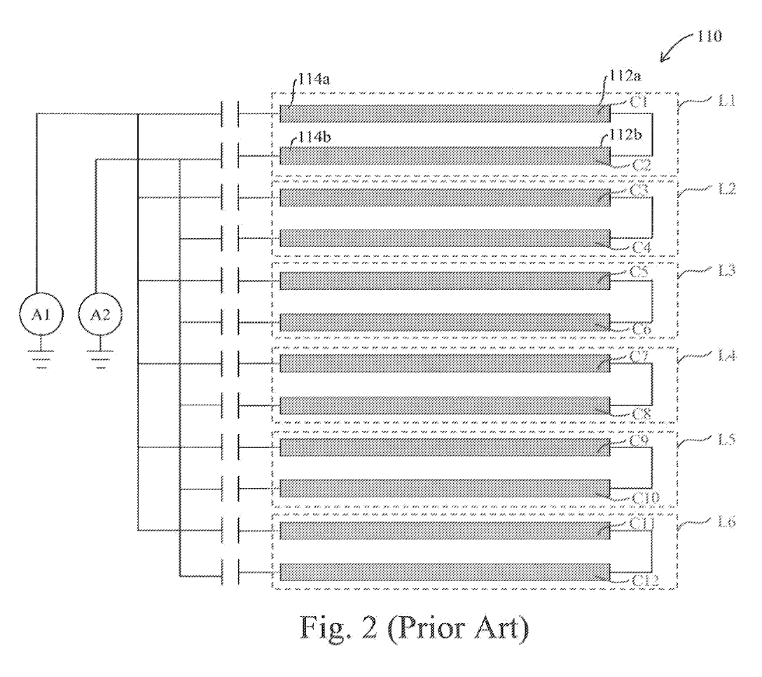

In some examples, to compensate for the temperature differences among different lamps, the lamp (e.g., C1) having the highest position is paired with the lamp (e.g., C12) having the lowest position to form a quasi-U-shaped lamp (e.g., L1, enclosed by dashed lines). The lamp (e.g., C2) having the second highest position is paired with the lamp (e.g., C11) having the second lowest position to form a quasi-U-shaped lamp (e.g., L2 enclosed in dashed lines), and so forth. Using this configuration, the electric currents flowing through different quasi-U-shaped lamps (e.g., L1 to L6) are substantially the same. This is in contrast to the example shown in FIG. 2, in which adjacent lamps (e.g., C1 and C2) are connected to form quasi-U-shaped lamps. In the example of FIG. 2, the quasi-U-shaped lamps having higher positions (e.g., L1) will have higher electric currents than the quasi-U-shaped lamps having lower positions (e.g., L6).

In the example of FIG. 3, several quasi-U-shaped lamps, such as L1 to L5, each include two lamps that are spaced apart with at least one other lamp in between. For example, quasi-U-shaped lamp L1 includes lamps C1 and C2 that are spaced apart with lamps C2 to C11 in between. Quasi-U-shaped lamp L5 includes lamps C5 and C8 that are spaced apart with lamps C6 to C7 in between.

In the example of FIG. 3, each lamp 22 includes a first end 24a and a second end 24b. The first end 24a of the lamp C1 is connected to the first end 24a of the lamp C12 to form the quasi-U-shaped lamp L1. Similarly, the first end 24a of the lamp C2 is connected to the first end 24a of the lamp C11 to form the quasi-U-shaped lamp L2, and so forth. The signal lines for connecting each pair of lamps can be positioned on a circuit board 16 located at, e.g., the right side of the lamps 22 in FIG. 3. The quasi-U-shaped lamp L1 to L6 each has a luminance characteristics similar to a U-shape or C-shape lamp (i.e., a lamp having an elongated tube bent in U-shape or C-shape).

The backlight module 20 includes an inverter 10 that has two power sources A1 and A2 for powering the lamps 22. The power sources A1 and A2 have different phases, e.g., 180° out of phase. The inverter 10 is positioned at one side of the lamps 22 (the left side in FIG. 3). The power sources A1 and A2 are connected to the second ends 24b of the lamps 22 so that the power lines between the power sources and the lamps can be short. The power lines carry high voltages, so having shorter power lines results in lower leakage currents. Ballast capacitors 12 are coupled between the power sources and the lamps 22 for generating the ballast voltage. In this example, the power source A1 is coupled to the second end 24b of the odd-numbered lamps, e.g., C1, C3, C5, C7, C9, and C11. The power source A2 is coupled to the second end 24b of the even-numbered lamps, e.g., C1, C3, C5, C7, C9, and C11.

The lamp connection configuration shown in FIG. 3 has the advantage of compensating a higher lamp current due to a higher lamp temperature by a lower lamp current due to a lower lamp temperature. For example, comparing quasi-U-shaped lamps L1 and L6, the lamp C1 is hotter than the lamp C6, and the lamp C12 is cooler than the lamp C7. By connecting C1 to C12, the tendency to have a higher current due to a higher temperature in C I (relative to that of C6) is offset by a tendency to have a lower current due to a lower temperature in C12 (relative to that of C7), so that the lamp current flowing through lamps C1 and C12 will be substantially the same as the lamp current flowing through lamps C6 and C7. The same analysis can be applied to the other quasi-U-shaped lamps L2 to L5.

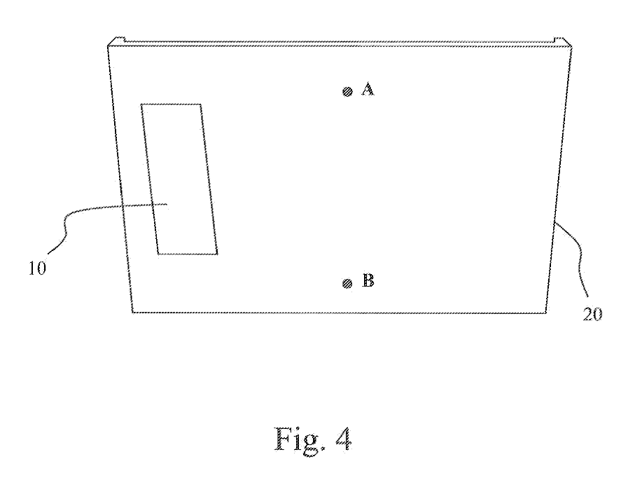

Referring to FIG. 4, experiments were performed, and temperatures were measured at two locations A and B of the backlight module 20. During the experiments, an upper area (near location A) of the backlight module 20 is covered with a plastic cloth to increase the temperature difference between the upper area and a lower area (around location B) of the backlight module 20. As the data below shows, even when the temperature differences between the upper and lower areas are enhanced, the lamp currents flowing through different quasi-U-shaped lamps are still substantially similar.

Mounted on the backside of the backlight module is a control board (not shown) that has circuitry for controlling the display panel and the backlight module 20. For example, the control board may include a timing controller that receives data and control signals from a host device (e.g., a computer), and controls data drivers and gate drivers to drive the pixels of the display panel. The control board may generate heat that increases the temperature of the lamps 22.

Table 1 shows lamp currents for the various quasi-U-shaped lamps L1 to L6 that are measured when the control board is located at an upper portion of the backside of the backlight module 20.

TABLE 1

| Quasi-U Lamp | Lamp Current (mA) | Note |
|---|---|---|
| L1 | 5.745 | |
| L2 | 5.667 | |
| L3 | 6.275 | Maximum |
| L4 | 5.451 | |
| L5 | 5.892 | |
| L6 | 5.448 | Minimum |

The temperature of location A is 47.7° C., and the temperature of the location B is 37.4° C. In Table 1, the difference between the maximum lamp current and the minimum lamp current (A1) is equal to 6.275−5.448=0.827 mA. As the data in Table 1 shows, even though the lamps and the control board generate heat that causes the temperatures of the lamps C1 to C12 to be different, the electric currents flowing through the quasi-U-shaped lamps do not vary significantly.

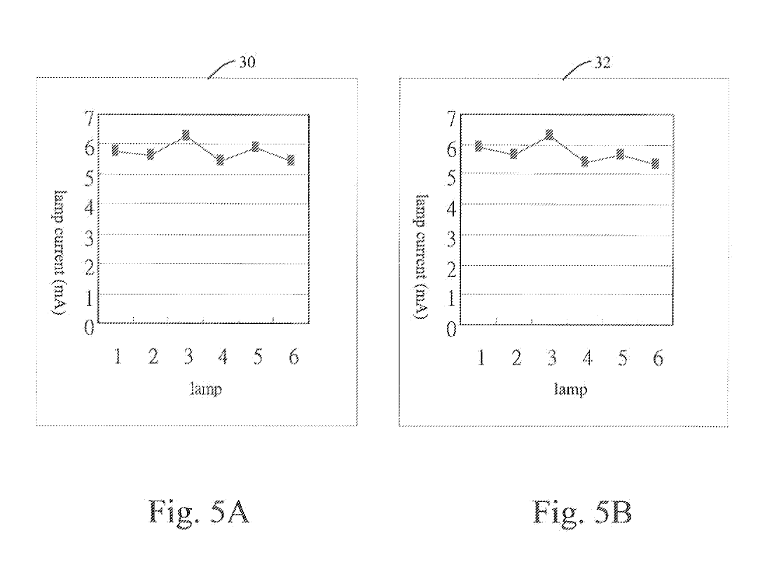

FIG. 5A is a graph 30 that shows the variation in lamp currents among different lamps. The data points in the graph 30 are obtained from Table 1.

Table 2 shows lamp currents that are measured when the control board is located at a lower portion of the backside of the backlight module. The same backlight module 20 was used but rotated 180° so that the control board changed from being located at an upper portion to a lower portion of the backlight module 20.

TABLE 2

| Quasi-U Lamp | Lamp Current (mA) | Note |
|---|---|---|
| L1 | 5.893 | |
| L2 | 5.645 | |
| L3 | 6.293 | Maximum |
| L4 | 5.424 | |
| L5 | 5.693 | |
| L6 | 5.367 | Minimum |

In Table 2, the difference between the maximum lamp current and the minimum lamp current (ΔI) equals to 6.293−5.367=0.926 mA. The temperature of the location A is 37.8° C., and the temperature of the location B is 48.0° C. As the data in Table 2 shows, even though the lamps and the control board generate heat that causes the temperatures of the lamps C1 to C12 to be different, the electric currents flowing through the quasi-U-shaped lamps do not vary significantly.

FIG. 5B is a graph 32 that shows the variation in lamp current among different lamps. The data points in the graph 32 are obtained from Table 2.

For comparison, the lamp currents of the quasi-U-shaped lamps in FIG. 2 are measured. Note that each of the quasi-U-shaped lamps in FIG. 2 includes two lamps that are adjacent to each other. Table 3 shows lamp currents of the backlight module 110 of FIG. 2. The control board is located at an upper portion of the backside of the backlight module 110.

TABLE 3

| Quasi-U Lamp | Lamp Current (mA) | Note |
|---|---|---|
| L1 | 6.21 | Top Lamp |
| L2 | 6.49 | Maximum |
| L3 | 6.259 | |
| L4 | 5.254 | Minimum |
| L5 | 5.474 | |
| L6 | 5.569 | Bottom Lamp |

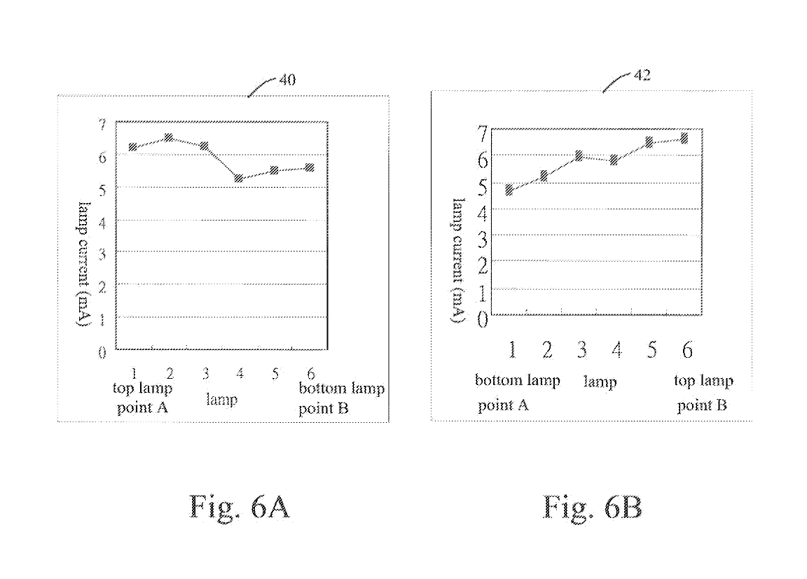

In Table 3, the difference between the maximum lamp current and the minimum lamp current (ΔI) is equal to 6.49−5.254=1.236 mA. The temperature of the location A is 47.4° C., and the temperature of the location B is 37.4° C. FIG. 6A is a graph 40 that shows the variation in lamp current among different lamps of the backlight module 110 of FIG. 2. The data points in the graph 40 are obtained from Table 3.

Table 4 shows lamp currents that are measured when the control board is located at a lower portion of the backside of the backlight module 110 of FIG. 2 (e.g., by turning the backlight module 110 upside down).

TABLE 4

| Quasi-U Lamp | Lamp Current (mA) | Note |
|---|---|---|
| L1 | 4.67 | Bottom Lamp |
| | | Minimum |
| L2 | 5.172 | |
| L3 | 5.947 | |
| L4 | 5.805 | |
| L5 | 6.45 | |
| L6 | 6.619 | Top Lamp |
| | | Maximum |

In Table 4, the difference between the maximum lamp current and the minimum lamp current (ΔI) equals to 6.619−4.67=1.949 mA. The temperature of the location A is 37.4° C., and the temperature of Point B is 49.5° C. FIG. 6B is a graph 42 that shows the variation in lamp current among different lamps of FIG. 2. The data points in the graph 42 are obtained from Table 4.

The difference between the maximum and minimum lamp currents in Table 1 is smaller than that shown in Table 3, and the difference between the maximum and minimum lamp currents in Table 2 is smaller than that shown in Table 4. This indicates that the backlight module 20 of FIG. 3 will have a more uniform luminance than that of the backlight module 110 of FIG. 2.

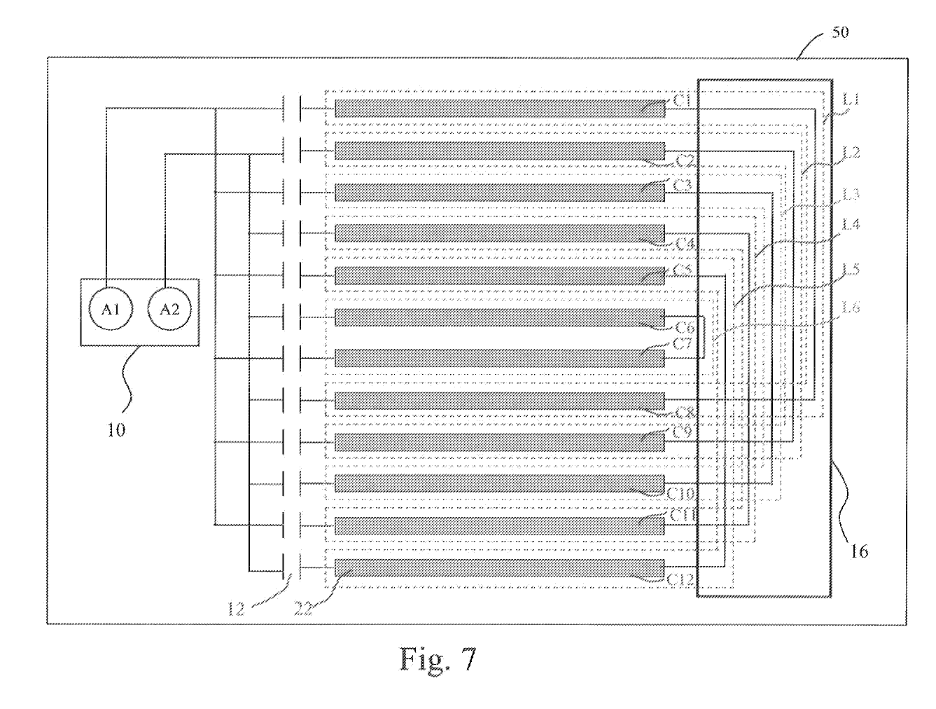

FIG. 7 is a schematic diagram of an example of a backlight module 50 of a display that includes elongated lamps 22 (e.g., C1 to C12) similar to those of the backlight module 20 of FIG. 3. The difference between the backlight modules 50 and 20 is that, in the backlight module 50, the lamp C1 is connected to the lamp C8 to form the quasi-U-shaped lamp L1, and the lamp C2 is connected to the lamp C9 to form the quasi-U-shaped lamp L2. Similarly, quasi-U-shaped lamps L3, L4, L5, and L6 are formed by connecting pairs of lamps (C3, C10), (C4, C11), (C5, C12), and (C6, C7), respectively.

Table 5 shows lamp currents of the backlight module 50 of FIG. 7. The control board is located at an upper portion of the backside of the backlight module 50.

TABLE 5

| Quasi-U Lamp | Lamp Current (mA) | Note |
|---|---|---|
| L1 | 5.917 | |
| L2 | 5.665 | Minimum |
| L3 | 6.023 | Maximum |
| L4 | 5.925 | |
| L5 | 5.902 | |
| L6 | 5.924 | |

In Table 5, the difference between the maximum lamp current and the minimum lamp current (ΔI) is equal to 6.023−5.665=0.358 mA. The temperature of the location A is 48.6° C., and the temperature of the location B is 37.2° C.

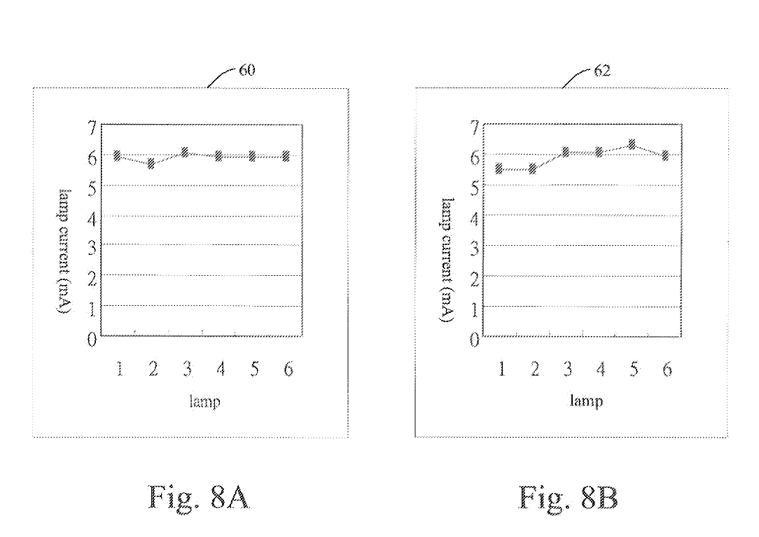

FIG. 8A is a graph 60 that shows the variations in lamp currents among different lamps. The data points in the graph 60 are obtained from Table 5.

Table 6 shows lamp currents of the backlight module 50 of FIG. 7. The measurements were made with the control board located at a lower portion of the backside of the backlight module 50 (e.g., by turning the module 50 upside down).

TABLE 6

| Quasi-U Lamp | Lamp Current (mA) | Note |
|---|---|---|
| L1 | 5.486 | Minimum |
| L2 | 5.499 | |
| L3 | 6.063 | |
| L4 | 6.081 | |
| L5 | 6.317 | Maximum |
| L6 | 5.915 | |

In Table 6, the difference between the maximum lamp current and the minimum lamp current (ΔI) is equal to 6.317−5.486=0.831 mA. The temperature of the location A is 37.6° C., and the temperature of the location B is 48.6° C.

FIG. 8B is a graph 62 that shows the variation in lamp current among different lamps. The data points in the graph 62 are obtained from Table 6.

The difference between the maximum and minimum lamp currents in Table 5 is smaller than that shown in Table 3, and the difference between the maximum and minimum lamp currents in Table 6 is smaller than that shown in Table 4. This indicates that the backlight module 50 of FIG. 7 will have a more uniform luminance than that of the backlight module 110 of FIG. 2.

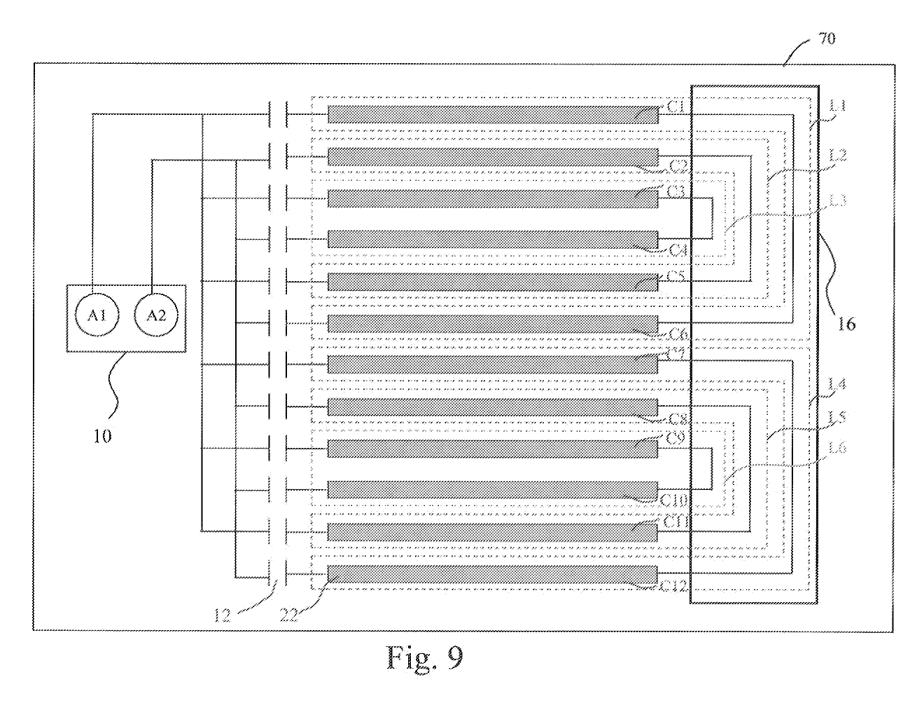

FIG. 9 is a schematic diagram of an example of a backlight module 70 of a display that includes elongated lamps 22 (e.g., C1 to C12) similar to those of the backlight module 20 of FIG. 3. The difference between the backlight modules 70 and 20 is that, in the backlight module 70, the lamps C1 and C6 are connected to form a quasi-U-shaped lamp L1, and the lamps C2 and C5 are connected to form a quasi-U-shaped lamp L2. Similarly, quasi-U-shaped lamps L3, L4, L5, and L6 are formed by connecting pairs of lamps (C3, C4), (C7, C12), (C8, C11), and (C9, C10), respectively.

Table 7 shows lamp currents of the backlight module 70 of FIG. 9. The lamp currents are measured when the control board is located at an upper portion of the backside of the backlight module 70.

TABLE 7

| Quasi-U Lamp | Lamp Current (mA) | Note |
|---|---|---|
| L1 | 6.348 | Maximum |
| L2 | 6.251 | |
| L3 | 6.626 | |
| L4 | 5.402 | Minimum |
| L5 | 5.433 | |
| L6 | 5.586 | |

In Table 7, the difference between the maximum lamp current and the minimum lamp current (ΔI) is equal to 6.348−5.402=0.946 mA. The temperature of the location A is 48.6° C., and the temperature of the location B is 36.9° C.

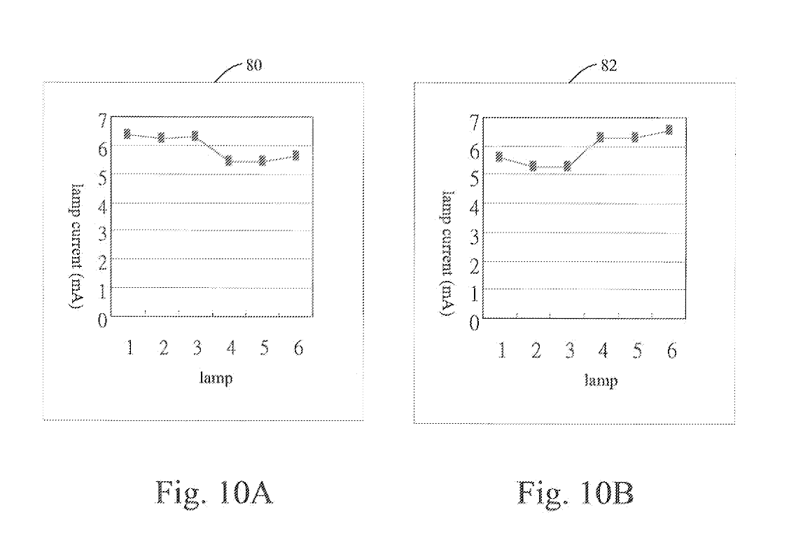

FIG. 10A is a graph 80 that shows the variations in lamp currents among different lamps. The data points in the graph 60 are obtained from Table 5.

Table 8 shows lamp currents that are measured when the control board is located at a lower portion of the backside of the backlight module 70 of FIG. 9 (e.g., by rotating the backlight module 70 upside down).

TABLE 8

| Quasi-U Lamp | Lamp Current (mA) | Note |
|---|---|---|
| L1 | 5.613 | |
| L2 | 5.256 | Minimum |
| L3 | 5.311 | |
| L4 | 6.298 | |
| L5 | 6.311 | |
| L6 | 6.541 | Maximum |

In Table 8, the difference between the maximum lamp current and the minimum lamp current (ΔI) is equal to 6.541−5.256=1.285 mA. The temperature of the location A is 37.4° C., and the temperature of Point B is 48.7° C.

FIG. 10B is a graph 82 that shows the variation in lamp current among different lamps. The data points in the graph 82 are obtained from Table 8.

The difference between the maximum and minimum lamp currents in Table 7 is smaller than that shown in Table 3, and the difference between the maximum and minimum lamp currents in Table 8 is smaller than that shown in Table 4. This indicates that the backlight module 70 of FIG. 9 will have a more uniform luminance than that of the backlight module 110 of FIG. 2.

Table 9 shows a comparison of the measurement results of the backlight module 110 (FIG. 2), backlight module 20 (FIG. 3), backlight module 50 (FIG. 7), and backlight module 70 (FIG. 9).

TABLE 9

| | Backlight | Backlight | Backlight | Backlight |
|---|---|---|---|---|
| | module | module | module | module |
| | 110 of | 20 of | 50 of | 70 of |
| | ΔI (mA) | ΔI (mA) | ΔI (mA) | ΔI (mA) |
| Control | 1.236 | 0.827 | 0.358 | 0.946 |
| board | | | | |
| at upper | | | | |
| position | | | | |
| Control | 1.949 | 0.926 | 0.831 | 1.285 |
| board | | | | |
| at lower | | | | |
| position | | | | |
| ΔΔI | 0.713 | 0.099 | 0.473 | 0.339 |

In Table 9, the backlight module 20 has the smallest ΔΔI value. This indicates that the method for connecting pairs of lamps to form the quasi-U-shaped lamps of the backlight module 20 of FIG. 3 is better than the other examples.

Although some implementations have been discussed above, other implementations and applications are also within the scope of the following claims. For example, the lamps 22 can have different shapes and lengths from those described above. The connection of pairs of lamps can be different from those described above. The inverter 10 can have more than two power sources.

What is claimed is:

1. An apparatus comprising:
a backlight module of a display, the backlight module comprising elongated lamps that comprise at least a pair of lamps having a first lamp and a second lamp that are electrically connected in series and being spaced apart with at least a third lamp positioned between the first and second lamps.

2. The apparatus of claim 1 wherein the lamps are connected in pairs in which the pairs of lamps are selected to compensate for differences in temperatures of the lamps during operation of the lamps.

3. The apparatus of claim 1 wherein the pair of lamps are connected in a quasi-U-shape.

4. The apparatus of claim 1, further comprising a circuit board having at least one signal line for connecting the at least one pair of lamps.

5. The apparatus of claim 1 wherein the elongated lamps extend along directions that are parallel to one another.

6. The apparatus of claim 1 wherein the backlight module comprises an inverter to provide power to the lamps.

7. The apparatus of claim 6 wherein the first lamp has a first end electrically coupled to the inverter, the second lamp has a first end electrically coupled to the inverter, and the first lamp has a second end electrically coupled to a second end of the second lamp.

8. The apparatus of claim 7 wherein the backlight module comprises a first ballast capacitor connected between the inverter and first end of the first lamp, and a second ballast capacitor connected between the inverter and first end of the second lamp.

9. The apparatus of claim 6 wherein the backlight module comprises ballast capacitors each connected between the inverter and one of the lamps.

10. The apparatus of claim 6 wherein the inverter comprises two alternating-current power sources.

11. The apparatus of claim 10 wherein the lamps are positioned in sequence, one of the two alternating-current power sources providing power for odd-numbered lamps, and the other of the two alternating-current power sources providing power for even-numbered lamps.

12. The apparatus of claim 1 wherein the lamps comprise at least one of cold cathode fluorescent lamps and external electrode fluorescent lamps.

13. The apparatus of claim 1 wherein the pair of lamps has luminance characteristics similar to a U-shape or C-shape lamp.

14. The apparatus of claim 1 wherein each of the elongated lamps extend along a direction parallel to a row of pixels of the display.

15. The apparatus of claim 1 wherein the lamps are connected to compensate for temperature variations in the lamps to enable the backlight module to have a luminance that is more uniform than a backlight module having pairs of lamps connected in series in which each pair includes lamps that are adjacent to each other.

16. The apparatus of claim 1 wherein the lamps comprise m lamps positioned in sequence in which the n-th lamp has an end that is electrically coupled to an end of the (m+1−n)-th lamp.

17. The apparatus of claim 1 wherein the pair of lamps includes a lamp having the highest position and a lamp having the lowest position among the lamps.

18. A display comprising:
a display panel comprising pixels; and
a backlight module to provide backlight for the display panel, the backlight module comprising
an inverter to provide power, and
elongated fluorescent lamps that comprise at least a first fluorescent lamp and a second fluorescent lamp that are electrically connected in series, in which the first fluorescent lamp has a first end electrically coupled to the inverter, the second fluorescent lamp has a first end electrically coupled to the inverter, the first fluorescent lamp has a second end electrically coupled to a second end of the second fluorescent lamp, and the first and second fluorescent lamps are spaced apart with at least a third fluorescent lamp positioned between the first and second fluorescent lamps.

19. A method comprising:
compensating a difference in luminance of different lamps of a backlight module of a display by electrically coupling a first one of the lamps to a second one of the lamps that is spaced apart from the first one of the lamps in which at least a third one of the lamps is positioned between the first one and second one of the lamps.

20. The method of claim 19, further comprising balancing the temperatures of the first one and second one of the lamps during operation of the first one and second one of the lamps.

21. The method of claim 19, further comprising compensating variation in electric current flowing through the lamps by electrically coupling a first one of the lamps to a second one of the lamps that are spaced apart from the first one of the lamps in which at least a third one of the lamps is positioned between the first one and the second one of the lamps.

22. The method of claim 19, further comprising coupling a ballast capacitor between a power source and each of the lamps.

23. The method of claim 19 wherein the lamps comprise at least one of cold cathode fluorescent lamps and external electrode fluorescent lamps.

24. The method of claim 19, further comprising powering the lamps using two alternating-current power sources.

25. The method of claim 19 wherein the lamps are positioned in sequence, and the method further comprises coupling a first alternating-current power source to odd-numbered lamps and coupling a second alternating-current power source to even-numbered lamps.

26. The method of claim 19, further comprising connecting the first one of the lamps to the second one of the lamps using a signal line on a circuit board.

27. The method of claim 19, further comprising illuminating a liquid crystal display panel using the backlight module.
